(19) United States
(12) Patent Application Publication
(10) Pub. No.: US 2026/0017116 A1
(43) Pub. Date: Jan. 15, 2026

(54) APPLICATION PARTITIONING BASED ON RESOURCE CONSUMPTION

(71) Applicant: INTERNATIONAL BUSINESS MACHINES CORPORATION, Armonk, NY (US)

(72) Inventors: Fabio DE OLIVEIRA FRANCO, Toronto (CA); Diane CHALMERS, Rochester, MN (US); Leonard Wijendran THEIVENDRA, Toronto (CA); Anuradha RAMAMOORTHY, Cary, NC (US)

(21) Appl. No.: 18/770,867

(22) Filed: Jul. 12, 2024

(51) Int. Cl. G06F 9/50

(52) U.S. Cl. CPC G06F 9/5077; G06F 9/5027

(57) ABSTRACT

Application partitioning includes executing uses cases on an application, which executes methods of objects of the application, capturing resource consumption data associated with the execution of the use cases, the resource consumption data including processing time consumption to execute the methods and estimated memory allocated for executing the methods, generating a similarity comparison that provides comparisons between the objects based on the processing time consumption and the estimated memory allocated, grouping the objects into a set of microservice partitions.

### BACKGROUND

Aspects described herein relate to modernizing applications. More specifically, aspects described herein relate to approaches for partitioning an application, such as a monolithic application, and even more specifically, to approaches for partitioning an application into microservices.

### SUMMARY

Shortcomings of the prior art are overcome and additional advantages are provided through the provision of a computer-implemented method. The method executes, on an application, a plurality of use cases of the application. The executing the plurality of use cases executes a plurality of methods of a plurality of objects of the application. The method additionally captures resource consumption data associated with the execution of the plurality of use cases. The capture may be by an agent executing in conjunction with the application. The resource consumption data includes processing time consumption to execute the plurality of methods and estimated memory allocated for executing the plurality of methods. Further, the method generates a similarity comparison based on the captured resource consumption data associated with the execution of the plurality of use cases. The similarity comparison provides comparisons between the objects based on the processing time consumption to execute the plurality of methods and the estimated memory allocated. The method also groups the plurality of objects into a set of microservice partitions. The grouping may be performed using a clustering algorithm and based on the generated similarity comparison. The grouping provides a plurality of groups of the objects. Each group corresponds to a microservice partition of the set of microservice partitions. Each object of the plurality of objects is grouped into one group of the plurality of groups, and each group of the plurality of groups provides a microservice partition with one or more of the plurality of objects.

Additional aspects of the present disclosure are directed to systems and computer program products configured to perform the methods described above and herein. The present summary is not intended to illustrate each aspect of, every implementation of, and/or every embodiment of the present disclosure. Additional features and advantages are realized through the concepts described herein.

### BRIEF DESCRIPTION OF THE DRAWINGS

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

FIG. 1 depicts an example computing environment to incorporate and/or use aspects described herein;

FIG. 2 depicts an example process for an application partitioning scheme, in accordance with aspects described herein;

FIG. 3 depicts an example process graph and associated resource consumption data for an application based on execution of use cases, in accordance with aspects described herein;

FIG. 4 depicts further details of example application partitioning code, in accordance with aspects described herein; and

FIG. 5 depicts an example process for application partitioning, in accordance with aspects described herein.

### DETAILED DESCRIPTION

Described herein are approaches for partitioning an application, for instance partitioning a monolithic application. Aspects are described herein with reference to so-called ‘monolithic’ applications, referring to applications that are self-contained and independent from other applications, though aspects described herein may be used to partition other applications that do not necessarily satisfy all characteristics of the monolithic stye of software architecture.

It is sometimes desired to partition a monolithic application, for instance to partition the application into microservices. Such application partitioning allows extension of the functions of the monolithic application to more modern architectures, e.g., via microservice offerings, which offer more flexibility than a monolithic application, and other advantages.

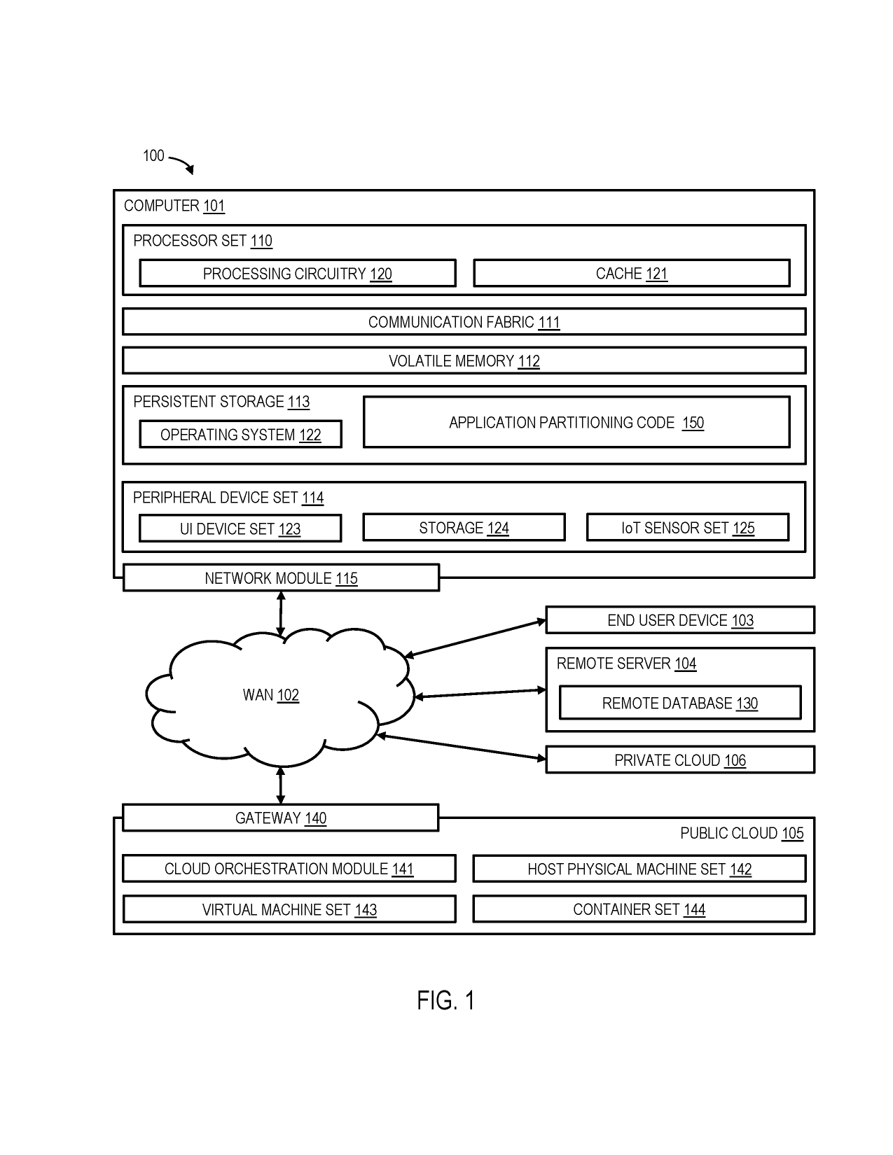

One or more embodiments described herein may be incorporated in, performed by, and/or used by a computing environment, such as computing environment 100 of FIG. 1. As examples, a computing environment may be of various architecture(s) and of various type(s), including, but not limited to: personal computing, client-server, distributed, virtual, emulated, partitioned, non-partitioned, cloud-based, quantum, grid, time-sharing, cluster, peer-to-peer, mobile, having one node or multiple nodes, having one processor or multiple processors, and/or any other type of environment and/or configuration, etc. that is capable of executing process(es) that perform any combination of one or more aspects described herein. Therefore, aspects described and claimed herein are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as application partitioning code 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication Fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud Computing Services and/or Microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The computing environment described above in FIG. 1 is only one example of a computing environment to incorporate, perform, and/or use aspect(s) of the present disclosure. Other examples are possible. For instance, in one or more embodiments, one or more of the components/modules of FIG. 1 are not included in the computing environment and/or are not used for one or more aspects of the present disclosure. Further, in one or more embodiments, additional and/or other components/modules may be used. Other variations are possible.

Computer-implemented methods, computer systems and computer program products relating to one or more aspects are described and claimed herein. Each of the embodiments of the computer program product may be embodiments of each computer system and/or each computer-implemented method and vice-versa. Further, each of the embodiments is separable and optional from one another. Moreover, embodiments may be combined with one another. Each of the embodiments of the computer program product may be combinable with aspects and/or embodiments of each computer system and/or computer-implemented method, and vice-versa. Further, it is noted that advantages described or set-forth explicitly or implicitly herein may not be present in all embodiments described herein, and are not necessarily required of all embodiments described herein.

As noted, it is sometimes desired to partition an application, for instance a monolithic application, into microservices because of the flexibility and other features that microservices offer as compared to being deployed as, e.g., a monolithic application. The process of partitioning a monolithic application into an optimized set of microservices is not necessarily straight-forward or easy. It is generally a manual, ad-hoc, subjective, time-consuming, and error-prone process involving software architects and developers. While some automated tools exist to assist in the partitioning, these generally rely on indirect ways to reduce processing time and/or other resources by minimizing inter-partition calls (that is, method calls between objects of different partitions). An algorithm might determine the number of such method calls between objects/classes and make a partitioning recommendation with an aim of reducing that number of calls.

In this manner, conventional algorithms might consider a number of calls between objects to help inform partitioning into microservices. While the overall partitioning workload might be reduced in these situations (since there is expected to be fewer calls between partitions), that approach can also lead to unexpected results because the number of calls an object makes to other objects does not necessarily imply increased process time. For instance, in many situations, it might be the complexity of the calls, rather than the number of the calls, which is more impactful in optimizing the partitioning scheme to partition the application into microservices. Take, for example, an object that consumes a relatively large amount of processing resources (e.g., central processing units (CPUs), cores, CPU time, cycles, or the like; also referred to as compute resources) but does not make a particularly high number of calls to other objects. In this case, if the partitioning does not take the usage of compute resources into account and places this object together with others (potentially those that are also particularly consuming of compute resources) in a same partition, then this could increase the overall cost even further. A similar situation can arise in the case of memory/storage consumption for the object as well. This is to say that a conventional practice of focusing on the number of calls between objects is not necessarily an appropriate point of emphasis for a partitioning scheme to partition the application’s objects into microservices.

In accordance with aspects described herein, approaches are presented for providing application partitioning recommendations, for instance recommendations based on resource consumption data, such as compute consumption and memory allocation. Thus, aspects take into consideration resource consumption/allocation factors when determining how to partition an application (e.g., a monolithic application) into partitions. In one or more embodiments, approaches use processing time and memory cost/usage as a heuristic to guide the partitioning process to provide more efficient partitioning recommendations. Consequently, the resulting microservices are more efficient and may be more easily scaled than those resulting from conventional partitioning approaches. Additionally, this helps modernize monolithic applications into microservices using key performance metrics. Some conventional techniques for recommending how to refactor monolithic applications do not take such performance metrics into consideration when determining how to partition the application.

Aspects of application partitioning described herein can assist users in modernizing their applications, for instance by enabling them to move the application to a cloud platform, and, as part of that, transform the application to microservices (also referred to as ‘refactoring’ the application). Thus, aspects enable the user to move to microservices after taking into account performance, which may be one of the key factors that prevents the user from moving to microservices in the first place.

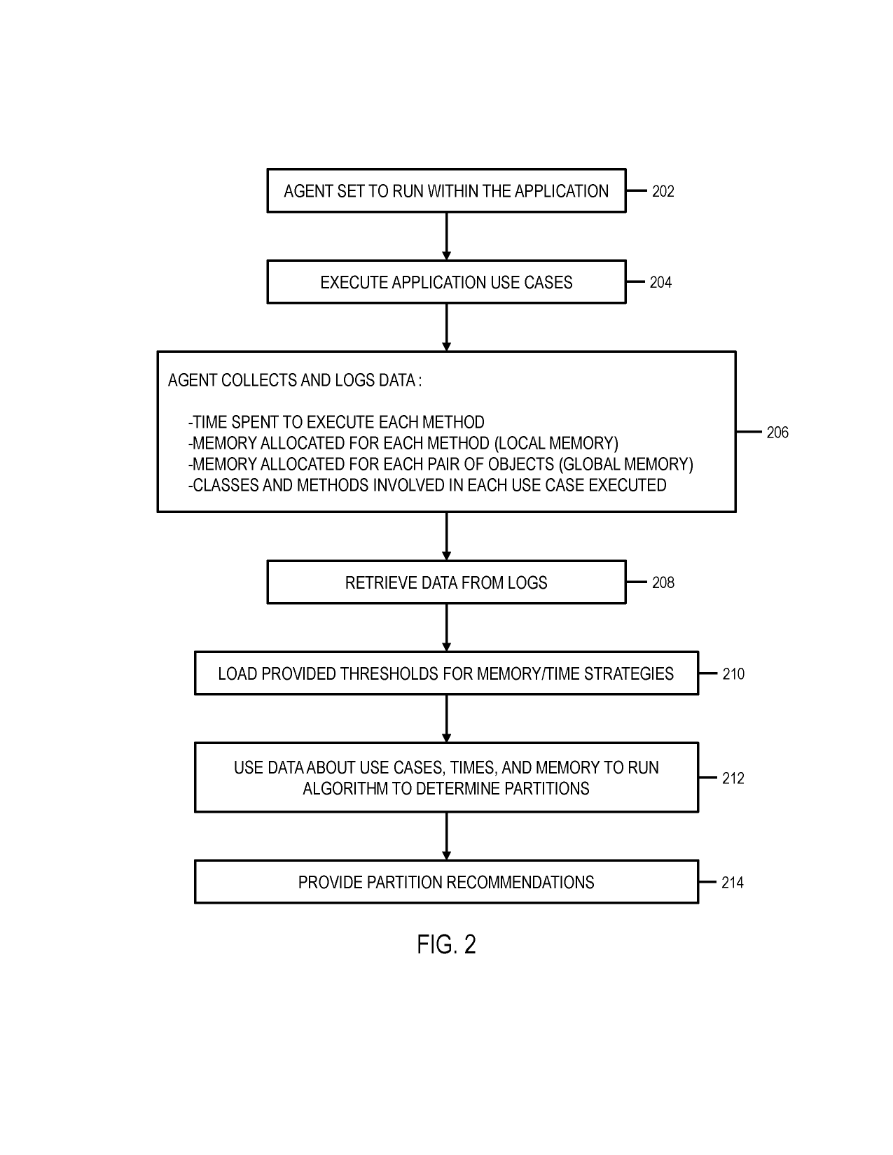

Aspects are now described with reference to FIG. 2, which depicts an example process for an application partitioning scheme, in accordance with aspects described herein. In one or more embodiments, a proposed approach leverages runtime traces to provide functional grouping to optimize process time and/or memory usage. In this manner, a system captures application complexity data related to, e.g., memory usage and the process time as a heuristic measure to perform a partitioning recommendation.

To facilitate collection of useful data, and referring to FIG. 2, the process sets (installs, places, etc.) (202) an agent to execute in conjunction with the monolithic application, for instance to run within the application or alongside the application to inspect activity thereof. In one or more embodiments, the agent is placed on an application server of the application, which runs the application to execute use cases of the application. In one or more embodiments, the application is a Java-based application, and the agent is a Java agent placed in the Java application server and configured to run together with the Java application.

The process proceeds by executing (204), on the monolithic application, use cases of the monolithic application. The monolithic application includes objects (which may be, for instance, particular instances of classes of the application) that includes methods that can be invoked/executed. The execution of the use cases executes methods of objects of the monolithic application. In one or more embodiments, it may be desired to select use cases that cause all, many, a majority, or at least a threshold percentage or number of methods and/or objects to be invoked by way of the use cases. This may be desired to provide a more complete picture of application performance. In one or more embodiments, the most likely use cases of the application may be a focus of the executing, with fringe use cases being omitted, for instance, though in other examples, the use cases represent an exhaustive coverage of the use cases that the application provides. Many scenarios are possible.

The process continues with the agent collecting and logging (206) data related to various properties of application execution. In one or more embodiments in which the application is a Java application, the agent, e.g., a Java agent, uses Java instrument capabilities to inspect the application code.

In this aspect (206), the process leverages the agent to capture resource consumption data associated with the execution of the use cases. The resource consumption data includes, for instance, processing time consumption to execute the methods, and estimated memory allocated for executing the methods.

As shown by FIG. 2, the data includes process time data per method (time spent to execute each method). Thus, the processing time consumption (of the captured resource consumption data) to execute the methods includes, for each method, a respective processing time consumption to execute the method. In this regard, a set of methods is called during the execution of a use case. When a method is called, the agent can log, e.g., print in the application log, the start time and the end time of the method execution. The delta reflected is the amount of time spent in a single method execution of a given object (e.g., object of a given class). In this manner, the agent can print the process time and/or data to the application log during use case execution and determine the process time for each method. In some situations, various methods might be invoked by various use cases and/or a given use cases might invoke one or more methods more than once. In these or other situations where a method is called and performed multiple times, then this results in a number of examples (samples) of method execution and consequently the process time associated with those executions. Therefore, a representative process time could be taken for that method, for instance some composite or calculation based on the different samples from each execution. As one example, the process times could be averaged and the result could be taken as being representative of the process time to execute an instance of the method, though various other representative process times may be determined based on statistical or other calculations.

As further shown by FIG. 2, the data also includes memory usage. Application objects can hold data related to varying data types. In the context of a Java application, there are Java primitive data types and Java non-primitive data types. This can be defined at a global class level or local method level. Each primitive data type has a defined memory size consumption. Each non-primitive data type uses a set of primitive and/or non-primitive data types to be constructed, and thus analyzing a non-primitive data type recursively allows the agent to compute memory size consumption of a non-primitive data type. However, given dynamic behavior of memory allocation and deallocation, in one or more embodiments it may not be possible to determine exact memory consumption. Nonetheless, it is possible to determine an estimated average. Thus, in accordance with aspects described herein, memory consumption (also referred to herein as usage) may be estimated at two levels:

-Estimated memory allocated by a method call (‘local memory’ or LM): The estimated memory allocated for executing the methods (which is part of the captured resource consumption data) includes, for each method of the methods, a respective memory allocated for executing the method. In this case, the agent can compute the memory allocated specifically for executing a method and then, for instance when finalizing method execution, print out the result to the application log. In this manner, the estimated memory allocated for the method executed is accounted, while other (‘global memory’ – see below) allocated is not accounted for in this aspect. Similar to above, in some situations, various methods might be invoked by various use cases and/or a given use cases might invoke one or more methods more than once. In these or other situations where a method is called and performed multiple times, then this results in a number of examples (samples) of method execution and consequently allocation of memory associated with those executions. Therefore, a representative LM could be taken for that method, for instance some composite or calculation based on the different samples from each execution. As one example, the LM could be averaged and the result could be taken as being representative of the LM allocation to execute an instance of the method, though various other representative LMs may be determined based on statistical or other calculations.

-Estimated memory allocated for each pair of objects interacting with each other, as source and target (‘global memory’ or GM): The estimated memory allocated for executing the methods (which is part of the captured resource consumption data) also includes, for each pair of objects with interaction between one another during execution of a method, a respective memory allocated for the interaction. In this aspect, and during a method execution, the agent can print to the application log the total amount of memory allocated for a current object (e.g., object of a given class), the ‘source’ (that is, not just at the method level, but the actual memory spent to allocate the entire object) and the memory allocated by any other object that interacts with the current object, that is, the ‘target’. In this case, an initial cost for the memory allocation for the pair is calculated (i.e., an initial cost for the memory allocation for the pair is calculated using the amount of memory for the current object/class, the ‘source’, and ‘target’), and then a delta value is added due to class-level variables being potentially modified by a method call. In this regard, the method call might potentially modify a variable, thus a delta value can be added. The delta value can be calculated based on what is modified in the variable. For example, if an array changes, this consumes additional memory and therefore the delta value can change to account for this. The total memory cost for the source-target interaction may be printed to the application log. Similar to above, in some situations, various methods might be invoked by various use cases and/or a given use cases might invoke one or more methods more than once. In these or other situations where a method is called and performed multiple times, then this results in a number of examples (samples) of method execution and consequently allocation of memory associated with those executions. Therefore, a representative GM could be taken for that method, for instance some composite or calculation based on the different samples from each execution. As one example, the GM could be averaged and the result could be taken as being representative of the GM allocation to execute an instance of the method, though various other representative GMs may be determined based on statistical or other calculations.

Additionally or alternatively, a highest source-target memory cost may be used in the computation. The highest in this regard can be the highest (peak) memory allocation observed in given timeframe, for instance. For multiple executions of the same source-target pair, the average for the highest n (n >=1) peak memory cost execution(s) can be found in the logs and used as the GM for the source-target pair, for instance.

-Classes and methods involved in each use case executed: During execution of a use case, the agent prints to the logs a class name (e.g., a Fully Qualified Class Name (FQCN)) and method information related to the methods and classes exercised by the use case. This can be used to identify the methods and interactions (for which PT, LM, and GM are tracked) by use case, as this may be useful in subsequent aspects of the process, such as, for instance, prioritization done as part of the grouping/partitioning algorithm.

Capturing of the resource consumption data at 206 based on executing the use cases and the agent collecting and logging the data discussed above provides indicators of the complexity of application components, including methods, objects, and the associated classes for the different use cases. The data collected can reflect, as described, process time per method (PT), estimated memory allocated by a method call (LM), and estimated memory allocated by each source-target pair (GM). This data can be retrieved (208) from the logs. Additionally, the process loads (210) thresholds for memory/time strategies such as discussed in connection with 212.

The process continues by using (212) the data about the use cases, time, and memory to run an algorithm to determine the partitions. For instance, the process uses these aforementioned measures (e.g., PT, LM, and GM) in conjunction with the use case information to guide a partition recommendation approach. As part of this, and in particular embodiments, the measures are used with a clustering algorithm.

In accordance with an example approach, PT, LM, and GM are used in the computation of a similarity comparison. Thus, the process generates a similarity comparison based on the captured resource consumption data (e.g., PT, LM, GM) associated with the execution of the use cases, and the similarity comparison provides comparisons between the objects based on the processing time consumption to execute the methods and on the estimated memory allocated. Similarity between objects may be a function of, e.g., process time consumption and/or memory allocation (local and/or global) associated with the objects, as examples. In one or more embodiments, as part of this similarity comparison, the process obtains weight(s) on various measure(s), such as processing time consumption and/or estimated memory allocated, for use in generating the similarity comparison, and the generation of the similarity comparison is based on the weights. In a particular example, the weight(s) are provided as one or more value(s), indication(s), setting(s), or threshold(s), defined by the user, which are used to define the weight(s) of the measures/parameters (PT, LM, and/or GM) used in the comparison generation. Weights provide a way to control the relevance of the different measures depending on what is desired to emphasize for the scenario. In some examples, the similarity comparison is or includes a similarity matrix, such as a similarity matrix as described in Kalia et al, “Mono2Micro: A Practical and Effective Tool for Decomposing Monolithic Java Applications to Microservices”, Proceedings of the 29th ACM Joint Meeting on European Software Engineering Conference and Symposium on the Foundations of Software Engineering, Association for Computing Machinery, ESEC/FSE August 23–28, 2021.

Then, the processing groups, using a clustering algorithm and based on the generated similarity comparison, the objects into a set of microservice partitions, where the grouping provides a plurality of groups of the objects, with each group corresponding to a microservice partition of the set of microservice partitions, each object of the objects is grouped into one group of the plurality of groups, and each group, of the groups, provides a microservice partition with one or more of the objects. In other words, each group corresponds to a respective partition of the application, for instance a partition that is to be implemented as a respective microservice different from the microservices implementing the other groups/partitions.

In one or more embodiments, the clustering algorithm includes an artificial-intelligence based hierarchical clustering algorithm that groups objects by similarity based on the generated similarity comparison. For instance, an artificial intelligence (AI) machine learning (ML)-based hierarchical clustering algorithm groups, based on training, similar objects (or at least objects that are to remain together in the partitioning) into clusters (partitions) based on the similarity matrix or other similarity comparison. An example hierarchical algorithm iterates over the groups and merges object clusters based on a distance statistic. For example, the algorithm uses Jaccard distance values to merge cluster(s). In this regard, another threshold that may be loaded (at 210) is a configurable threshold (e.g., a maximum or minimum) number of groups/clusters into which the grouping is to group the objects. The threshold, if a maximum, can be used as a stop-criterion to end the clustering. At that point, a group of objects (e.g., as instances of given classes) can be observed in each group (which corresponds to a partition and set of object(s)/class(es) for that partition). This provides (214) partition recommendations that can then be implemented as microservices – for instance to build, for each partition, a respective microservice from the object(s)/class(es) in that partition. In some examples, a system, such as a system performing aspects of the process of FIG. 2 or another system, uses the partition recommendation and automatically performing partitioning/refactoring of the application. In specific examples, the system refactors the application by taking application portions (for instance code portions) and constructing a set of microservices from the portions.

In one or more embodiments, the grouping prioritizes grouping into a same partition the objects associated with a given use case that have relatively higher processing time consumption or higher local memory usage than other objects. That is, the grouping can analyze each use case to determine which objects have higher processing time consumption and/or local memory usage, e.g., relative to other objects of that use case. It may be desired to keep together the objects that tend to have the highest processing time and/or memory usage. Thus, in accordance with this aspect, objects/classes with relatively large values for PT and/or LM can be placed within the same partition; if the processor time and/or memory allocated costs are significant, then splitting those objects/classes into different partitions could contribute to more time and memory allocated to execute the same use case scenario. Partitioning based on this may be taken on an individual use case basis or based on a composite/aggregate across multiple different use cases.

In contrast to the above, in one or more embodiments the grouping prioritizes grouping into a same partition the objects associated with a given use case that have a relatively smaller global memory usage than other objects. That is, the grouping can analyze each use case to determine which objects have smaller global memory usage, e.g., relative to other objects of that use case. It may be desired to keep together the objects that tend to have the smallest global memory usage. Thus, in accordance with this aspect, objects/classes with relatively small values for GM can be placed within the same partition; if the global memory allocated costs are small, the objects can be placed in the same partition because they will likely contribute in only a trivial or minimal way, if at all, to the overall complexity and cost of the use case scenario. Partitioning based on this may be taken on an individual use case basis or based on a composite/aggregate across multiple different use cases.

It is noted that the use of weight(s) can inform and influence the particular strategy taken, for instance the degree to which different grouping strategies (for instance to prioritize grouping based on higher processing time consumption or higher local memory usage, or to prioritize grouping based on smaller global memory usage) factor into the grouping determination. A user/expert can leverage this flexibility to determine which strategy/strategies to use and how strongly each should influence the partitioning determination.

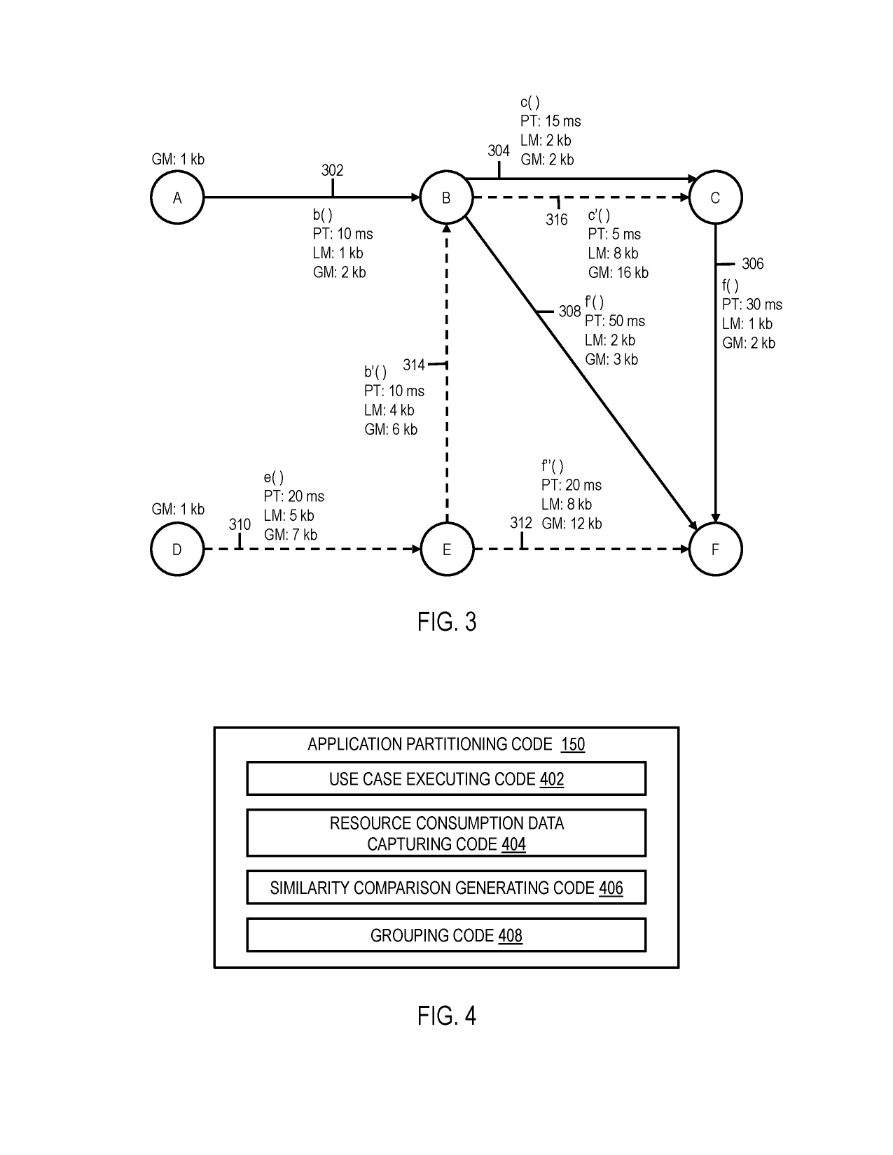

To facilitate an understanding of aspects described herein, FIG. 3 depicts an example process graph and associated resource consumption data for an application based on execution of use cases, in accordance with aspects described herein. The graph includes six nodes labeled A, B, C, D, E, and F representing six objects (e.g., instances of classes). The arrows extending between nodes show call flows; an arrow extending from one node (a source node corresponding to a source object) to another node (a target node corresponding to a target object) represents a call, by the source object, of a method of the target object. Also shown are labels for the method called, the expected memory allocated for the object in that call, and the time spent to execute that method. The notation n( ) denotes the call of method n of the target object. Thus, as an example, object A calls method b( ) of object B here. PT refers to the process time – the time spent to execute method n( ), LM refers to local memory – the estimated allocated memory to execute method n( ), and GM refers to global memory – the estimated memory amount to allocate the object X. Solid arrows in FIG. 3 represent a first of two use cases analyzed, specifically one involving objects/classes A, B, C, and F, while dashed arrows in FIG. 3 represent a second of two use cases analyzed, specifically one involving objects/classes D, E, B, C, and F.

The first use case involves objects A, B, C, and F, and calls 302, 304, 306 and 308. GM associated with allocating object A is 1 kilobyte (kb). Call 302 is by object A for method b( ) of object B. Resource consumption data associated with call 302 is: PT=10 milliseconds (ms), LM=1 kb, and GM=2 kb. Call 304 is by object B for method c( ) of object C. Resource consumption data associated with call 304 is: PT=15 ms, LM=2 kb, and GM=2 kb. Call 306 is by object C for method f( ) of object F. Resource consumption data associated with call 306 is: PT=30 ms, LM=1 kb, and GM=2 kb. Call 308 is by object B for another instance of method f( ) (thus referred to as f’( ) here) of object F. Resource consumption data associated with call 308 is: PT=50 ms, LM=2 kb, and GM=3 kb. It is seen that a same method may have different memory allocated based on the particular instance of the call.

The second use case involves objects D, E, B, C, and F, and calls 310, 312, 314 and 316. GM associated with allocating object D is 1 kb. Call 310 is by object D for method e( ) of object E. Resource consumption data associated with call 310 is: PT=20 ms, LM=5 kb, and GM=7 kb. Call 312 is by object E for another instance of method f( ) (thus referred to as f’’( ) here) of object F. Resource consumption data associated with call 312 is: PT=20 ms, LM=8 kb, and GM=12 kb. Call 314 is by object E for another instance method b( ) (thus referred to as b’( ) here) of object B. Resource consumption data associated with call 314 is: PT=10 ms, LM=4 kb, and GM=6 kb. Call 316 is by object B for another instance of method c( ) (thus referred to as c’( ) here) of object C. Resource consumption data associated with call 316 is: PT= 5 ms, LM=8 kb, and GM=16 kb.

For illustrating an example optimization on only the process times and using a functional grouping strategy, this might result in two clusters generated as follows:

-Partition 1 (objects A, B, C, F) with a total estimated process time to execute the first use case being the processing times of calls 302, 304, 306, and 308 = 10 ms +15 ms + 30 ms + 50 ms = 105 ms; and

-Partition 2 (objects D, E) with a total estimated process time to execute the second use case being at least the processing times of calls 310, 312, 314, and 316 = 20 ms + 10 ms + 5 ms + 20 ms = 55 ms. In practice, the processing time may be even greater because calls 312 and 314 are calls between objects of different partitions (inter-partitioning calls).

The arrangement above (A, B, C, F) results in the least potential process time of 105 ms. Changing the partitioning combination would increase this to greater than 105 ms, as splitting these objects will result in inter-partition calls because the flow would be split among partitions. The partitioning can seek to avoid creating inter-partition calls because they tend to be costly, and thus group objects between which calls are made.

For illustrating an example optimization on only the expected memory consumption, rather than on process times, and using a functional grouping strategy, this might result in two clusters generated as follows:

-Partition 1 (objects A, B, C) with a total estimated memory consumption of at least 27 kb. The local memory consumption to execute the first and second use cases is the total LM of the calls for methods of objects A, B, and C, namely 1 kb for the method b( ) call, 2 kb for the method c( ) call, 8 kb for the method c’( ) call, and 4 kb for the method b’( ) call = 15 kb. The global memory consumption to execute the first and second use cases is the total GM of the calls for methods of objects A, B, and C, namely 1 kb for object A, 2 kb for the method b( ) call, 2 kb for the method c( ) call, 16 kb for the method c’( ) call, and 6 kb for the method b’( ) call = 27 kb. 27 kb is the minimum memory consumption necessary to hold the intersection of the local memory (totaling 15 kb) and global memory (totaling 27 kb) to execute the first and second use cases.

-Partition 2 (D, E, F) with a total estimated memory consumption of at least 25 kb. The local memory consumption to execute the first and second use cases is the total LM of the calls for methods of objects D, E, and F, namely 5 kb for the method e( ) call, 1 kb for the method f( ) call, 2 kb for the method f’( ) call, and 8 kb for the method f’’( ) call = 16 kb. The global memory consumption to execute the first and second use cases is the total GM of the calls for methods of objects D, E, and F, namely 1 kb for object D, 7 kb for the method e( ) call, 2 kb for the method f( ) call, 3 kb for the method f’( ) call, and 12 kb for the method f’’( ) call = 25 kb. 25 kb is the minimum memory consumption necessary to hold the intersection of local memory (totaling 16 kb) and global memory (totaling 25 kb) to execute the first and second use cases.

In the above partitioning example, the first use case holds at least 3 kb of local memory in each partition and holds at least 5 kb of global memory in each partition. Similarly, the second use case holds at least 12 kb of local memory in Partition 1 and at least 13 kb in the Partition 2 and holds at least 22 kb of global memory in Partition 1 and at least 20 kb in Partition 2.

To summarize the memory allocation in this example, the use cases hold 3 kb + 12 kb = 15 kb of local memory in Partition 1 and 5 kb + 22 kb = 27 kb of global memory in Partition 1, while the use cases hold 3 kb + 13 kb = 16 kb of local memory in Partition 2 and 5 kb + 20 kb = 25 kb of global memory in Partition 2. This partitioning distribution balances the memory allocation to execute these two use cases; other arrangements (e.g., selection of use cases) could unbalance the estimated memory allocation. This example partitioning agrees with principles of microservice architecture, that is, the overall memory may be higher than the one consumed in running the original monolithic application, but each microservice (partition) will individually consume a lower footprint, making it easier to scale.

The above partitions are only examples. These could be determined by iterating through various candidate sets of groupings and analyzing those candidates, optionally informed by weights that control how much emphasis is given to different prioritization strategies. In some examples, an AI model is leveraged for this. In some examples, an optimization function is built with an objective for maximization or minimization in terms of the results of various groupings analyzed.

In one or more embodiments, the resource consumption data includes the processing time consumption to execute the plurality of methods or the estimated memory allocated for executing the plurality of methods, and not necessarily both. Additionally or alternatively, in one or more embodiments, the similarity comparison is generated based on the processing time consumption to execute the plurality of methods or the estimated memory allocated for executing the plurality of methods, and not necessarily both. Additionally or alternatively, in one or more embodiments, the grouping using the generated similarity comparison considers similarity comparison(s) using the processing time consumption to execute the plurality of methods or the estimated memory allocated for executing the plurality of methods, and not necessarily both, in grouping the plurality of objects into a set of microservice partitions.

Aspects described herein differ from other methods of refactoring that do not take into consideration resource consumption of the components as described herein. Aspects also differ from approaches that focus on scaling resources based on demand.

FIG. 4 depicts further details of example application partitioning code (e.g., application partitioning code 150 of FIG. 1) to incorporate and/or use aspects described herein. In one or more aspects, application partitioning code 150 includes, in one example, various sub-modules of code to be used to perform application partitioning. The sub-modules are, e.g., computer readable program code (e.g., instructions) in computer readable media, e.g., storage (persistent storage 113, cache 121, storage 124, other storage, as examples). The computer readable storage media may be part of one or more computer program products and the computer readable program code may be executed by and/or using one or more computing devices (e.g., one or more computers, such as computer(s) 101, computers of cloud 105/106, and/or other computers; one or more servers, such as remote server(s) 104 and/or other remote servers; one or more devices, such as end user device(s) 103 and/or other end user devices; one or more processors or nodes, such as processor(s) or node(s) of processor set 110 and/or other processor(s) or node(s); processing circuitry, such as processing circuitry 120 of processor set 110 and/or other processing circuitry; and/or other computing devices, etc.). Additional and/or other computers, servers, devices, processors, nodes, processing circuitry and/or computing devices may be used to execute one or more of the sub-modules and/or portions thereof. Many examples are possible.

Referring to FIG. 4 application partitioning code 150 includes use case executing code 402 for executing, on an application such as a monolithic application, a plurality of use cases of the application; resource consumption data capturing code 404 for capturing resource consumption data associated with the execution of the plurality of use cases; similarity comparison generating code 406 for generating a similarity comparison based on the captured resource consumption data; and grouping code 408 for grouping objects into a set of microservice partitions.

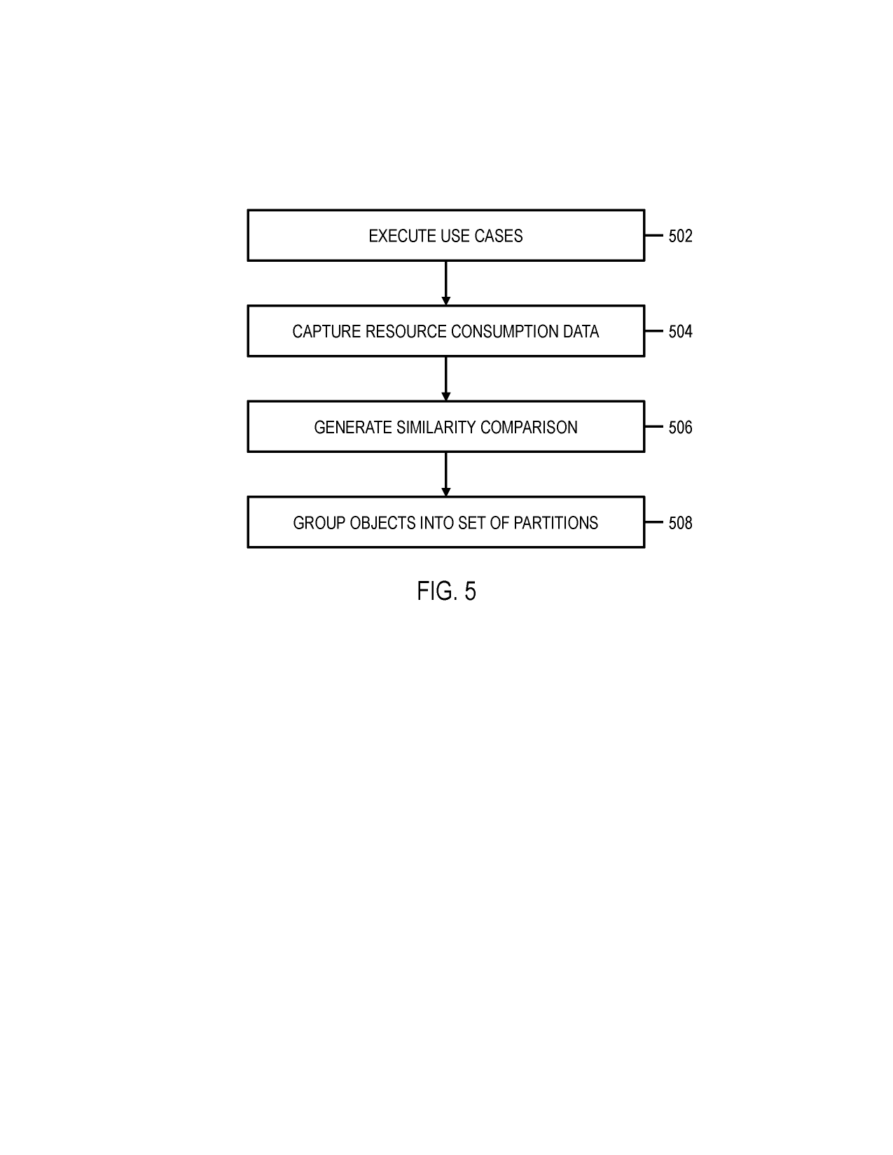

FIG. 5 depicts an example process for application partitioning, in accordance with aspects described herein. The process may be executed, in one or more examples, by a processor or processing circuitry of one or more computers/computer systems, such as those described herein, and more specifically those described with reference to FIG. 1. In one example, code or instructions implementing the process(es) of FIG. 5 are part of a module, such as code 150. In other examples, the code may be included in one or more modules and/or in one or more code sub-modules of the one or more code modules. Various options are available.

The process of FIG. 5 includes executing (502), on an application such as a monolithic application, a plurality of use cases of the application. Executing the plurality of use cases executes a plurality of methods of a plurality of objects of the application. The process additionally captures (504) resource consumption data associated with the execution of the plurality of use cases. This capturing may leverage an agent executing in conjunction with the application. The resource consumption data includes processing time consumption to execute the plurality of methods and estimated memory allocated for executing the plurality of methods, in examples.

In one or more embodiments, the processing time consumption to execute the plurality of methods includes, for each method of the plurality of methods, a respective processing time consumption to execute the method. In one or more embodiments, the estimated memory allocated for executing the plurality of methods includes, for each method of the plurality of methods, a respective memory allocated for executing the method. In one or more embodiments, the estimated memory allocated for executing the plurality of methods further includes, for each pair of objects, of the plurality of objects, with interaction between one another during execution of a method, a respective memory allocated for the interaction.

Continuing with FIG. 5, the process generates (506) a similarity comparison based on the captured resource consumption data associated with the execution of the plurality of use cases. The similarity comparison provides comparisons between the objects based on the processing time consumption to execute the plurality of methods and the estimated memory allocated. The process can optionally further include obtaining weights on the processing time consumption and the estimated memory allocated, the weights being for use in generating the similarity comparison, and the generating may be based on the weights. In one or more embodiments, the similarity comparison includes a similarity matrix.

The process continues by grouping (508), using a clustering algorithm and based on the generated similarity comparison, the plurality of objects into a set of microservice partitions. The grouping provides a plurality of groups of the objects, each group corresponding to a microservice partition of the set of microservice partitions. Each object of the plurality of objects is grouped into one group of the plurality of groups, and each group of the plurality of groups provides a microservice partition with one or more of the plurality of objects.

In one or more embodiments, the clustering algorithm includes an artificial-intelligence based hierarchical clustering algorithm that groups objects by similarity. In one or more embodiments, the artificial-intelligence based hierarchical clustering algorithm further merges object clusters based on a distance statistic.

The process could optionally also obtain a threshold number of groups into which the grouping is to group the plurality of objects. The threshold could be a maximum or a minimum, as examples.

In one or more embodiments, the grouping can prioritize grouping, into a same partition, objects associated with a given use case that have relatively higher processing time consumption or higher local memory usage than other objects of the plurality of objects. Additionally or alternatively, the grouping can prioritize grouping, into a same partition, objects associated with a given use case that have a relatively smaller global memory usage than other objects of the plurality of objects. These are only examples of prioritization schemes that can be taken for partitioning an application into partitions, for instance individual microservices.

In some examples, a system uses the output of the process of FIG. 5, for instance in the form of a partition recommendation, and automatically (at least partially, or fully) performs partitioning/refactoring of the application. In specific examples, the system refactors the application by taking application portions (for instance code portions) and constructing a set of microservices from the portions. The system could also deploy the microservices on the system or another system, either of which could be a cloud system.

Although various embodiments are described above, these are only examples.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiments are chosen and described in order to best explain various aspects and the practical application, and to enable others of ordinary skill in the art to understand various embodiments with various modifications as are suited to the particular use contemplated.

What is claimed is:

1. A computer-implemented method comprising:
executing, on an application, a plurality of use cases of the application, wherein executing the plurality of use cases executes a plurality of methods of a plurality of objects of the application;
capturing, by an agent executing in conjunction with the application, resource consumption data associated with the execution of the plurality of use cases, the resource consumption data including processing time consumption to execute the plurality of methods and estimated memory allocated for executing the plurality of methods;
generating a similarity comparison based on the captured resource consumption data associated with the execution of the plurality of use cases, the similarity comparison providing comparisons between the objects based on the processing time consumption to execute the plurality of methods and the estimated memory allocated; and
grouping, using a clustering algorithm and based on the generated similarity comparison, the plurality of objects into a set of microservice partitions, the grouping providing a plurality of groups of the objects, each group corresponding to a microservice partition of the set of microservice partitions, wherein each object of the plurality of objects is grouped into one group of the plurality of groups, and each group of the plurality of groups provides a microservice partition with one or more of the plurality of objects.

2. The method of claim 1, wherein the processing time consumption to execute the plurality of methods includes, for each method of the plurality of methods, a respective processing time consumption to execute the method.

3. The method of claim 2, wherein the estimated memory allocated for executing the plurality of methods includes, for each method of the plurality of methods, a respective memory allocated for executing the method.

4. The method of claim 3, wherein the estimated memory allocated for executing the plurality of methods further includes, for each pair of objects, of the plurality of objects, with interaction between one another during execution of a method, a respective memory allocated for the interaction.

5. The method of claim 1, further comprising obtaining weights on the processing time consumption and the estimated memory allocated for use in generating the similarity comparison, wherein the generating is based on the weights.

6. The method of claim 1, further comprising obtaining a threshold number of groups into which the grouping is to group the plurality of objects.

7. The method of claim 1, wherein the similarity comparison comprises a similarity matrix.

8. The method of claim 1, wherein the clustering algorithm comprises an artificial-intelligence based hierarchical clustering algorithm that groups objects by similarity, and wherein the artificial-intelligence based hierarchical clustering algorithm further merges object clusters based on a distance statistic.

9. The method of claim 1, wherein the grouping prioritizes grouping, into a same partition, objects associated with a given use case that have relatively higher processing time consumption or higher local memory usage than other objects of the plurality of objects.

10. The method of claim 1, wherein the grouping prioritizes grouping, into a same partition, objects associated with a given use case that have a relatively smaller global memory usage than other objects of the plurality of objects.

11. A computer system comprising:
at least one computing device;
a set of one or more computer readable storage media; and
program instructions, collectively stored in the set of one or more computer readable storage media, for causing the at least one computing device to perform computer operations including:
executing, on an application, a plurality of use cases of the application, wherein executing the plurality of use cases executes a plurality of methods of a plurality of objects of the application;
capturing, by an agent executing in conjunction with the application, resource consumption data associated with the execution of the plurality of use cases, the resource consumption data including processing time consumption to execute the plurality of methods and estimated memory allocated for executing the plurality of methods;
generating a similarity comparison based on the captured resource consumption data associated with the execution of the plurality of use cases, the similarity comparison providing comparisons between the objects based on the processing time consumption to execute the plurality of methods and the estimated memory allocated; and
grouping, using a clustering algorithm and based on the generated similarity comparison, the plurality of objects into a set of microservice partitions, the grouping providing a plurality of groups of the objects, each group corresponding to a microservice partition of the set of microservice partitions, wherein each object of the plurality of objects is grouped into one group of the plurality of groups, and each group of the plurality of groups provides a microservice partition with one or more of the plurality of objects.

12. The computer system of claim 11, wherein the processing time consumption to execute the plurality of methods includes, for each method of the plurality of methods, a respective processing time consumption to execute the method.

13. The computer system of claim 12, wherein the estimated memory allocated for executing the plurality of methods includes, for each method of the plurality of methods, a respective memory allocated for executing the method.

14. The computer system of claim 13, wherein the estimated memory allocated for executing the plurality of methods further includes, for each pair of objects, of the plurality of objects, with interaction between one another during execution of a method, a respective memory allocated for the interaction.

15. The computer system of claim 11, wherein the clustering algorithm comprises an artificial-intelligence based hierarchical clustering algorithm that groups objects by similarity, and wherein the artificial-intelligence based hierarchical clustering algorithm further merges object clusters based on a distance statistic.

16. A computer program product comprising:
a set of one or more computer readable storage media; and
program instructions, collectively stored in the set of one or more computer readable storage media, for causing at least one computing device to perform computer operations including:
executing, on an application, a plurality of use cases of the application, wherein executing the plurality of use cases executes a plurality of methods of a plurality of objects of the application;
capturing, by an agent executing in conjunction with the application, resource consumption data associated with the execution of the plurality of use cases, the resource consumption data including processing time consumption to execute the plurality of methods and estimated memory allocated for executing the plurality of methods;
generating a similarity comparison based on the captured resource consumption data associated with the execution of the plurality of use cases, the similarity comparison providing comparisons between the objects based on the processing time consumption to execute the plurality of methods and the estimated memory allocated; and
grouping, using a clustering algorithm and based on the generated similarity comparison, the plurality of objects into a set of microservice partitions, the grouping providing a plurality of groups of the objects, each group corresponding to a microservice partition of the set of microservice partitions, wherein each object of the plurality of objects is grouped into one group of the plurality of groups, and each group of the plurality of groups provides a microservice partition with one or more of the plurality of objects.

17. The computer program product of claim 16, wherein the processing time consumption to execute the plurality of methods includes, for each method of the plurality of methods, a respective processing time consumption to execute the method.

18. The computer program product of claim 17, wherein the estimated memory allocated for executing the plurality of methods includes, for each method of the plurality of methods, a respective memory allocated for executing the method.

19. The computer program product of claim 18, wherein the estimated memory allocated for executing the plurality of methods further includes, for each pair of objects, of the plurality of objects, with interaction between one another during execution of a method, a respective memory allocated for the interaction.

20. The computer program product of claim 16, wherein the clustering algorithm comprises an artificial-intelligence based hierarchical clustering algorithm that groups objects by similarity, and wherein the artificial-intelligence based hierarchical clustering algorithm further merges object clusters based on a distance statistic.
